(19) United States
(12) Patent Application Publication
(10) Pub. No.: US 2010/0095469 A1
(43) Pub. Date: Apr. 22, 2010

(54) Paint roller with tubular frame

(76) Inventor: Ren-Min Hu, Wujin (CN)

Correspondence Address: SALLY CHANG, 7F, NO. 3, ALLEY 32, SEC. 6 CHUNG-HSIAO EAST RD., TAIPEI, TAIWAN, R.O.C. 115, TAIPEI, 115, TW

(21) Appl. No.: 12/216,389

(22) Filed: Jul. 3, 2008

(51) Int. Cl. B05C 17/02

(52) U.S. Cl. 15/230.11

(57) ABSTRACT

The present invention is to provide a paint roller with tubular frame processed through less contamination process, lower material cost, light weight but durable in use. The present invention is to provide a paint roller with tubular frame includes, at least, a tubular axle (1); a cylinder (4) at a distal end of said axle (1); and a handle (3) at a proximal end of said axle (1); characterized in that: being processed through roll mill to reel stretch said axle (1) to form bent portions (2), which further processed through stamping machine to lengthen, flatten and bend the bent portions (2), where a cross section of said bent portions (2) shown a width larger than a height shaped in an overall flattened configuration (A).

### FIELD OF THE INVENTION

The present invention is related to an improved structure about paint roller with tubular frame for painting.

### BACKGROUND OF THE INVENTION

As shown in FIG. 1, a perspective view of an old fashioned paint roller with tubular frame is illustrated. Said paint roller (10) includes a solid axle (20); a cylinder (30) at a distal end of said axle (20); and a handle (40) at a proximal end of said axle (20). By means of said handy, old fashioned item, users can paint walls, floors, and other surfaces.

But, users became aware that drawbacks of the old fashioned item appeared as follows:

1. Not to meet environmental protection and green product requirements: due to the solid axle (20) is substantially made from traditional iron wire that must be shaped-through acid pickling and straight line wire drawing processes. Mass of hydrochloric acid and calcium carbonate consumed impacts on the environment.

2. Solid axle (20) is used as a main body of the paint roller with tubular frame. Materials for manufacturing purposes must be ordered, furnished at significant amounts. Material cost increases.

3. To retain strength demanded by users, the axle (20) must be thicker than ever. Weight is increased. For example, less exacting of working, lift and roll down the roller timely to make a “smooth even coverage”; the axle (20) still may be easily deformed, the cylinder (30) is not easily rotated about the axle (20).

Accordingly, the present invention is aimed to provide a frame which is connected by an axle is light and rigid, not to be out of shape.

### SUMMARY OF THE INVENTION

The present invention is to provide a paint roller with tubular frame processed through less contamination process, lower material cost, light weight but durable in use.

The present invention is to provide a paint roller with tubular frame includes, at least, a tubular axle (1); a cylinder (4) at a distal end of said axle (1); and

A handle (3) at a proximal end of said axle (1); characterized in that:

Being processed through roll mill to reel stretch said axle (1) to form bent portions (2), which further processed through stamping machine to lengthen, flatten and bend the bent portions (2), where a cross section of said bent portions (2) shown a width larger than a height shaped in an overall flattened configuration (A).

The paint roller with tubular frame of claim 1 wherein said flattened configuration (A) selected from one of the following: a rectangular shaped, an oval shaped, or a diamond shaped.

The paint roller with tubular frame of claim 1 wherein said cylinder (4) includes two wheel spacers (7), a first ferrule (5) and a second ferrule (6) disposed adjacent said two wheel spacers (7) respectively to form both ends of said cylinder (4); a plurality of steel wires (8) disposed between said first, second ferrules (5, 6) to shape a cylindrical symmetric hollowed out shaft.

### Advantages of Embodiments of the Invention

1. Selected portions of said tubular axle (1) are processed through reel stretching process by roll mill to lengthen, flatten, and bend said selected portions to form said bent portions (2), which are further processed through stamping process by stamping machine, cross sections of said bent portions is defined as a width larger than a height within a flattened configuration. Tubular axle (1) is therefore light weight and durable in use.

2. Tubular axle (1) carries a weight only ⅓ of a solid axle with a same diameter. Material cost can be saved.

3. To pull and stretch said tubular axle (1) through modes, or to weld said tubular axle (1) one by one, neither acid pickling nor phosphating treatment is required in manufacturing.

4. No other components need to be processed through any treatments to join together to the paint roller with tubular frame. Thereby, the tubular axle can be completely adapted to paint roller instead of old fashioned items.

5. Said tubular axle (1) is used instead of the solid axle (20) of old fashioned paint roller (10). Not only material cost can be saved, about ⅔ steel material used on solid axle (20) can be saved; but already lengthen, flatten and bend said tubular axle (1) to form said bent portions (2), which is already shaped into flattened configuration in shape; said cylinder (4) rotates about said tubular axle (1) regularly.

6. When processed and assembled, said tubular axle (1) is superior to said solid axle (20) as following: (a) Said solid axle (20) processed through stamping machine, which is easily damaged by said solid axle (20). While said tubular axle (1) can be stamped flattened in shape. Life expectancy of the stamping machine can be prolonged. (b) Finished solid axle (20) hooks into a handle (40) by an easily damaged end—to confront the tough handle with toughness of solid axle (20). While said tubular axle (1) fits into a handle (3) by a tubular end, which carries only ⅓ weight of said solid axle (20). Where the handle (3) made of plastics tightly fits over the tubular axle (1).

### BRIEF DESCRIPTION OF THE DRAWINGS

FIG. 1: is a perspective view of an old fashioned paint roller.

FIG. 2: is a perspective view of a paint roller with tubular frame of the present invention.

FIG. 3: is a sectional view of said bent portion of FIG. 2 in accordance with III-III of FIG. 2

FIG. 4: is an exploded view of said paint roller with tubular frame of the present invention.

FIG. 5: is a whole cross sectional view of the paint roller with tubular frame of the present invention.

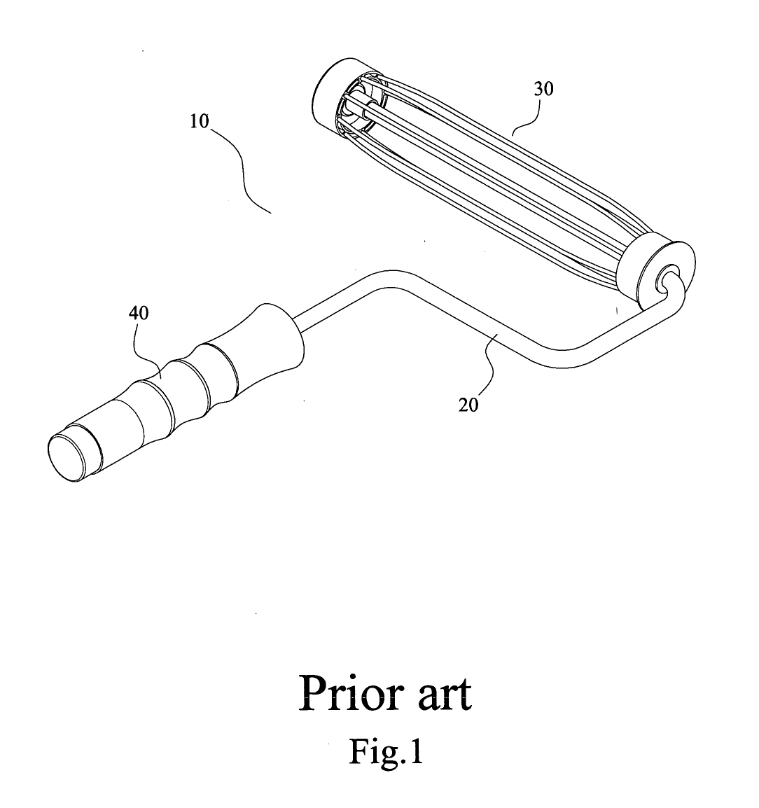

### DETAILED DESCRIPTION OF THE PREFERRED EMBODIMENTS OF THE INVENTION

The description is described according to the appended drawings hereinafter.

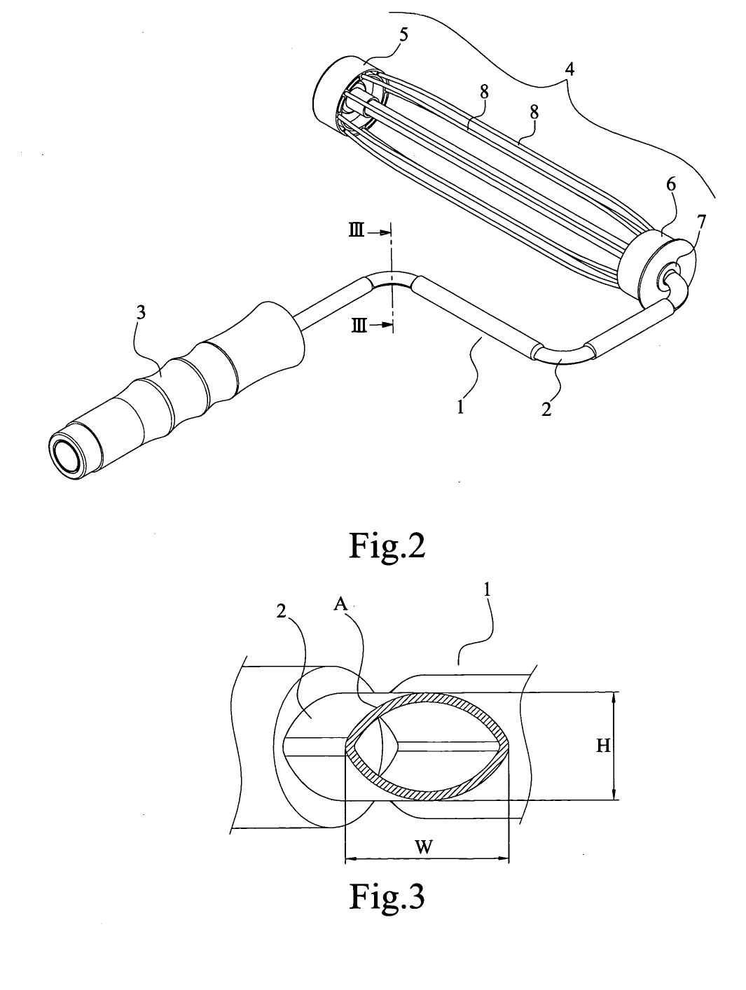

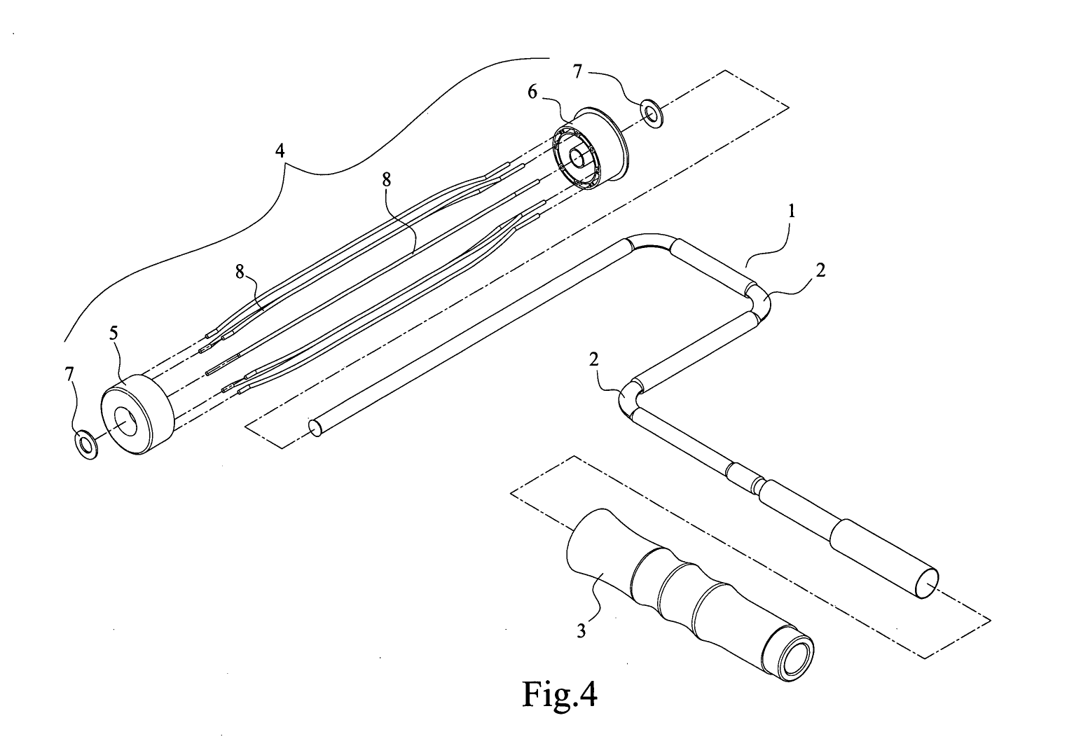

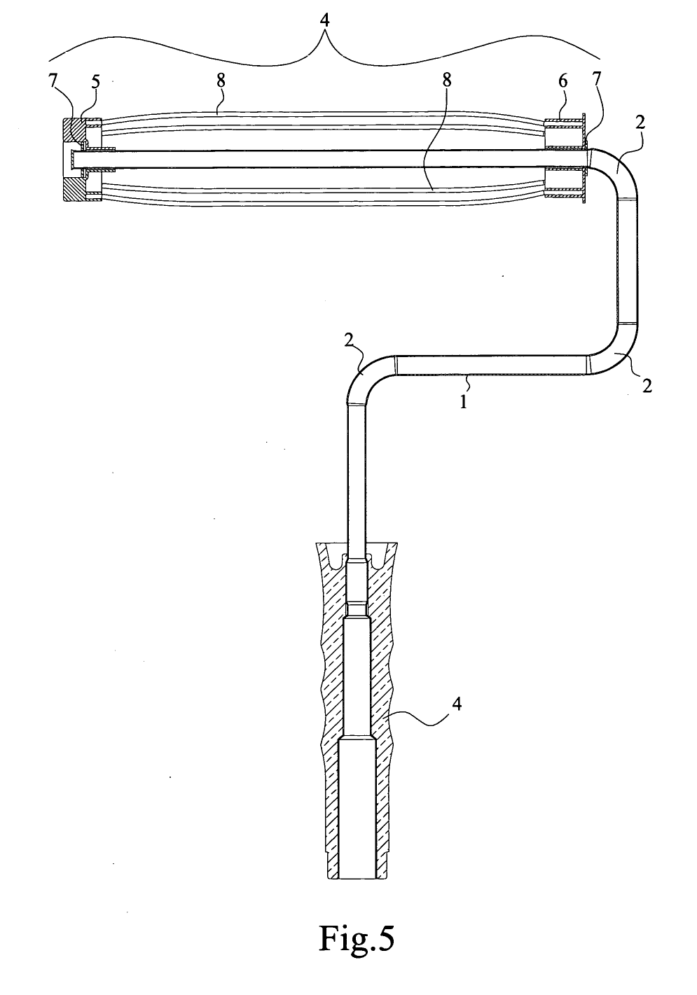

As shown in FIGS. 2-5, a frame includes, at least, a tubular axle (1); a cylinder (4) at a distal end of said axle (1); and

A handle (3) at a proximal end of said axle (1); characterized in that:

Being processed through roll mill to reel stretch said axle (1) to form bent portions (2), which further processed through stamping machine to lengthen, flatten and bend the bent portions (2), where a cross section of said bent portions (2) shown a width larger than a height shaped in an overall flattened configuration (A). (As shown in FIG. 3)

As above, selected portions of said tubular axle (1) are processed through reel stretching process by roll mill to lengthen, flatten, and bend said selected portions to form said bent portions (2), which are further processed through stamping process by stamping machine, cross sections of said bent portions is defined as a width larger than a height within a flattened configuration. Tubular axle (1) is therefore light weight and durable in use.

Further, said tubular axle (1) carries a weight only ⅓ of a solid axle with a same diameter. Material cost can be saved.

Moreover, to pull and stretch said tubular axle (1) through modes, or to weld said tubular axle (1) one by one, neither acid pickling nor phosphating treatment is required in manufacturing.

No other components need to be processed through any treatments to join together to the paint roller with tubular frame. Thereby, the tubular axle can be completely adapted to paint roller instead of old fashioned items.

Said tubular axle (1) is used instead of the solid axle (20) of old fashioned paint roller (10). Not only material cost can be saved, about ⅔ steel material used on solid axle (20) can be saved; but already lengthen, flatten and bend said tubular axle (1) to form said bent portions (2), which is already shaped into flattened configuration in shape; said cylinder (4) rotates about said tubular axle (1) regularly.

When processed and assembled, said tubular axle (1) is superior to said solid axle (20) as following: (a) Said solid axle (20) processed through stamping machine, which is easily damaged by said solid axle (20). While said tubular axle (1) can be stamped flattened in shape. Life expectancy of the stamping machine can be prolonged. (b) Finished solid axle (20) hooks into a handle (40) by an easily damaged end—to confront the tough handle with toughness of solid axle (20). While said tubular axle (1) fits into a handle (3) by a tubular end, which carries only ⅓ weight of said solid axle (20). Where the handle (3) made of plastics tightly fits over the tubular axle (1).

On the whole, the paint roller with tubular frame of the present invention is light weight, durable in use, environmental friendly. That is superior to said old fashioned paint roller (10).

Said flattened configuration (A) selected from one of the following: a rectangular shaped, an oval shaped, or a diamond shaped.

Said cylinder (4) includes two wheel spacers (7), a first ferrule (5) and a second ferrule (6) disposed adjacent said two wheel spacers (7) respectively to form both ends of said cylinder (4); a plurality of steel, wires (8) disposed between said first, second ferrules (5, 6) to shape a cylindrical symmetric hollowed out shaft.

1. A paint roller with tubular frame includes, at least, a tubular axle (1); a cylinder (4) at a distal end of said axle (1); and
a handle (3) at a proximal end of said axle (1); characterized in that:
said axle (1) comprising a bent portions (2), where a cross section of said bent portions (2) shown a width larger than a height shaped in an overall flattened configuration (A).

2. The frame of claim 1 wherein said flattened configuration (A) selected from one of the following: a rectangular shaped, an oval shaped, or a diamond shaped.

3. The frame of claim 1 wherein said cylinder (4) includes two wheel spacers (7), a first ferrule (5) and a second ferrule (6) disposed adjacent said two wheel spacers (7) respectively to form both ends of said cylinder (4); a plurality of steel wires (8) disposed between said first, second ferrules (5, 6) to shape a cylindrical symmetric hollowed out shaft.
